(19) United States
(12) Patent Application Publication
(10) Pub. No.: US 2010/0315205 A1
(43) Pub. Date: Dec. 16, 2010

(54) ASSOCIATED SET OF RADIO FREQUENCY IDENTFICATION ("RFID") TAGGED CONTAINERS FOR SPECIMENS FROM A PATIENT

(76) Inventor: William C. Egbert, Minneapolis, MN (US)

Correspondence Address: 3M INNOVATIVE PROPERTIES COMPANY, PO BOX 33427, ST. PAUL, MN, 55133-3427, US

(21) Appl. No.: 12/745,908

(22) PCT Filed: Nov. 18, 2008
(86) PCT No.: PCT/US08/83868

§ 371 Date: Aug. 5, 2010

Related U.S. Application Data
(60) Provisional application No. 61/012,697, filed on Dec. 10, 2007.

(51) Int. Cl. H04Q 5/22; G06K 19/067

(52) U.S. Cl. 340/10.51; 235/492

(57) ABSTRACT

Techniques are described for using radio-frequency identification (FID) tags and containers for specimens.

### TECHNICAL FIELD

The present invention relates to specimens, and more particularly containers for specimens having radio frequency identification tags.

### BACKGROUND OF THE INVENTION

Hospitals and clinics routinely collect biological specimens from patients, and analyze the specimens to diagnose diseases. For example, a surgeon may perform a biopsy of a tumor to extract a biopsy specimen, and a pathologist analyzes the biopsy specimen to determine whether the tumor is benign or malignant. During the process of collection, preparation of the specimen, and analysis, a single specimen undergoes numerous hand-offs between individuals, departments, and even different institutions. At each location, the specimen may be split into several constituent samples.

For example, a specimen from a patient may initially be placed in one or more labeled containers such as bottles. The bottles are typically then sent to an anatomic pathology lab, where the tissue may be cut and placed into labeled cassettes. Tissue from a single bottle may, for example, be divided into multiple cassettes. The tissue may then be dehydrated and embedded in wax to form a block. Next, one or more slides may then be prepared using tissue from a single specimen block. In particular, thin sections of the specimen block are shaved and placed on different labeled slides. The slides are stained and slip covers are added. The slides are then transferred from the lab to a pathologist's office, where the pathologist analyzes the slides and creates a pathology report that is added to the patient's record. Results of the pathology report are communicated to the patient. The remaining slides, blocks, or bottles may be archived.

Proper handling of patient-specific specimens is potentially one of the most important aspects of a specimen analysis process. Errors in the processing of the specimen can result in failures ranging from delays in processing and analysis, incorrect information being provided to a patient, and even harm to the patient. Such errors may even give rise to malpractice lawsuits. It is, therefore, important to properly identify each bottle, block, and slide preferably in a manner that enables proper handling and tracking of patient specimens.

The assignee of this patent application has filed previous patent applications related to specimen tracking. U.S. Ser. No. 11/683,940, “Specimen Tracking and Management.” (Eisenberg et al.), U.S. Ser. No. 11/683,933, “Specimen Tracking and Management Verification,” (Eisenberg et al.), U.S. Ser. No. 11/683,946, “Rule-Driven Specimen Tracking and Management,” (Eisenberg et al.), and U.S. Ser. No. 11/683,953, “Print Device for Specimen Tracking and Management, (Eisenberg et al.). Other tracking systems for hospital products and patients are known, such as U.S. Patent Application Publication No. 2006/0101129 (Rubertelli et al.), which discloses methods for delivering blood to the correct patient. However, Rubertelli et al. involves copying or transferring the same unique identifier code for one identification transponder to a second identification transponder, as opposed to each transponder having its own unique identification code, which does not provide a user any way to properly identify the source of the specimen and tracking the specimen as it is divided into additional samples and provided into different containers.

### SUMMARY OF THE INVENTION

One aspect of the present invention provides an associated set of radio frequency identification (“RFID”) tagged containers for collecting and processing one or more specimens from a patient. In one embodiment, the associated set of RFID tagged containers for collecting and processing one or more specimens from a patient, comprises: a first specimen container having a first RFID tag attached to the first container; a second specimen container having a second RFID tag attached to the second container; wherein the first specimen container includes a specimen from a patient, and the first RFID tag is programmed with the identification information associated with the patient and identification information associated with the first specimen container, wherein the second specimen container includes a portion of the specimen from the first specimen container, and the second RFID tag is programmed with at least the identification information from the first RFID tag and identification information associated with the second specimen container; wherein the first and second RFID tags include substantially the same communication protocol for reading data from or writing data to the RFID tags; and wherein the first and second RFID tags include integrated circuits having similar physical operating parameters.

In another embodiment, the associated set of RFID tagged containers for collecting and processing one or more specimens from a patient, comprises: a first specimen container having a first RFID tag attached to the first container; a second specimen container having a second RFID tag attached to the second container; a third specimen container having a third RFID tag attached to the third container; wherein the RFID tags include substantially the same communication protocol for reading data from or writing data to the RFID tags; and wherein the RFID tags include integrated circuits having similar physical operating parameters; wherein the RFID tags include antennas which are dissimilar in size; and wherein the first specimen container is a specimen bottle, the second specimen container is a specimen cassette, and the third specimen container is a specimen slide.

Yet another aspect of the present invention provides a method of forming an associated set of radio frequency identification (“RFID”) tagged containers for collecting and processing one or more specimens from a patient. In one embodiment, the method comprises: providing a first specimen container having a first RFID tag attached to the first container, a second specimen container having a second RFID tag attached to the second container, and a third specimen container having a third RFID tag attached to the first container; supplying the first specimen container with a specimen from a patient, supplying the second specimen container with a portion of the specimen from the first specimen container, supplying the third specimen container with a portion of the specimen from the second specimen container, programming the first RFID tag with the identification information associated with the patient and identification information associated with the first specimen container, programming the second RFID tag with at least the identification information from the first RFID tag and identification information associated with the second specimen container, programming the third RFID tag with at least the identification information from the second RFID tag and identification information associated the third specimen container; wherein the first, second, and third RFID tags include substantially the same communication protocol for reading data from or writing data to the RFID tags; and wherein the first, second, and third RFID tags include integrated circuits having similar physical operating parameters.

The above summary of the present invention is not intended to describe each disclosed embodiment or every implementation of the present invention. The Figures and the detailed description, which follow, more particularly exemplify illustrative embodiments.

### BRIEF DESCRIPTION OF THE DRAWINGS

The present invention will be further explained with reference to the appended Figures, wherein like structure is referred to by like numerals throughout the several views, and wherein:

FIG. 1 is a schematic illustration of a user interface, computing device, RFID reader and antenna in the form of a pad, and a set of RFID tagged containers of one embodiment of the present invention;

FIG. 2 illustrates one example of a first type of specimen container and RFID tag;

FIG. 3 illustrates one example of a second type of specimen container and RFID tag; and

FIG. 4 illustrates one example of a third type of specimen container and RFID tag;

### DETAILED DESCRIPTION OF THE INVENTION

In general, the invention relates to different sets of specimen containers, each having a radio frequency identification (RFID) tag associated with the container, where each associated set of specimen containers is affiliated with one patient. The RFID tags are used to manage patient-specific material throughout the entire process of collection, preparation, and analysis of specimens. For example, the set of RFID tags may be used to manage the patient-specific material starting with the collection of specimens from a patient at a hospital, through processing the specimens at a laboratory facility, to analysis of the specimens by a pathologist, and eventually into storage where materials may be archived. An RFID tag typically includes an integrated circuit operatively connected to an antenna that receives radio frequency (“RF”) energy from a source and backscatters RF energy in a manner well known in the art. The backscattered RF energy provides a signal that the RFID tag modulates to communicate information about the RFID tag and its associated article.

While various specimen tracking systems are known, it is important to be able to correctly identify the exact patient that is the source of each specimen. The present invention provides techniques for properly identifying the source of the specimen and enabling tracking of the specimen as it is divided into additional samples and provided in different containers.

In addition, the associated set of RFID tagged specimen containers of the present invention simplifies the design of the RFID system used for identifying and tracking the specimen containers. For example, the RFID tags in the associated set preferably include capabilities for communicating with an RFID reader using substantially the same or the same communication protocol. As another example, the RFID tags in the associated set preferably include integrated circuits having similar physical operating parameters. Both of these features assist in simplifying the ability of transferring identity information from one RFID tag to another (as explained below in more detail), and further, that the system software is simplified in that only one communication protocol is required for communication between RFID readers and tags anywhere in the process. Such a system makes it possible for one RFID system (readers, software, and host computer) to manage the original specimen and all its derivative samples.

Lastly, the RFID tags in the associated set of the present invention may be formed in a variety of sizes to allow them to be attached to different types of specimen containers. Further, the RFID tags in the associated set of the present invention are able to function in a variety of environments, such as those typically experienced in a laboratory or hospital.

Specimens taken from a patient may take many different forms. For example, the specimen could be an anatomical pathology specimen, a histology specimen, or cytology specimen.

Typically, patients arrive at a healthcare facility, e.g., a hospital, clinic or other institution, and are checked in at a patient intake site using a patient management system, such as an information management system. At this time, the patient may receive a patient identification wristband having an embedded RFID tag. Information within the specimen management system is synchronized to information within the patient management system. For example, a patient record within the specimen management system may be updated with a unique identifier of the RFID tag of the patent identification wristband as well as identification information (e.g., a patient identifier) that uniquely identifies the patient information within the information management system. For the purposes of this illustration, particularly in light of Table 1 below, assume two different patients have been checked in and the RFID tags on their wristbands include unique identification numbers, XYZ and ABC. After initial processing, the patient is typically transferred to an examination location or surgery room, where a practitioner collects one or more specimens. This may occur in the context of a variety of medical procedures. For example, the patient may have tissue removed during an endoscopy procedure. As another example, the patient may have a skin biopsy by a dermatologist. As yet another example, the patient may have a tumor or organ completely removed by a surgeon. The specimens are placed in one or more bottles having labels with RFID tags, i.e., only one specimen per bottle. The RFID tags of the bottles may be programmed to include patient identification information and a bottle identifier (ID) or other information.

For the purposes of this illustration, particularly in light of Table 1 below, assume there were two specimens taken from each patient, XYZ and ABC. The RFID tag attached to a first specimen bottle holds a specimen from patient XYZ and is programmed with identification information XYZ.123. The RFID tag attached to a second specimen bottle also holds a specimen from patient XYZ and is programmed with identification information XYZ.124. Since both RFID tags include the original patent identification information, XYZ, a user may easily ascertain that both specimen bottles contain samples from the same patient. The RFID tag attached to a third specimen bottle holds a specimen from patient ABC and is programmed with identification information ABC.223. The RFID tag attached to a fourth specimen bottle also holds a specimen from patient ABC and is programmed with identification information ABC.224. Since both RFID tags include the original patent identification information, ABC, a user may easily ascertain that both specimen bottles contain samples from the same patient. The specimen management system may then update the patient record to record the unique identifiers for the RFID tags of the particular bottles used to contain the patient's specimens.

The RFID tagged specimen bottles are then transferred to a laboratory, such as an anatomic pathology laboratory, which may be at a different location within the institution or off-site. The RFID tags of the bottles may be interrogated at different locations during the process of transferring the bottles from the surgical room to the laboratory. At the laboratory, information may be read from the RFID tag on the bottles by an RFID reader associated with the specimen management system. For example, the RFID reader may be used to check the RFID tagged bottles into the laboratory by updating status information for the patient's record within the specimen management system to reflect that the RFID tagged bottles for the patient are now located in the laboratory.

At the laboratory, the specimens contained within the RFID tagged bottles are processed, as will be described in further detail below. At this time, specimen cassettes and specimen slides are typically prepared at the laboratory, and each include an RFID tag. The specimen cassette typically holds a block of treated specimen (i.e., a dehydrated specimen embedded in wax). A specimen slide or microscope slide typically includes a portion of the block of treated specimen, which has been shaved off of the block and dyed.

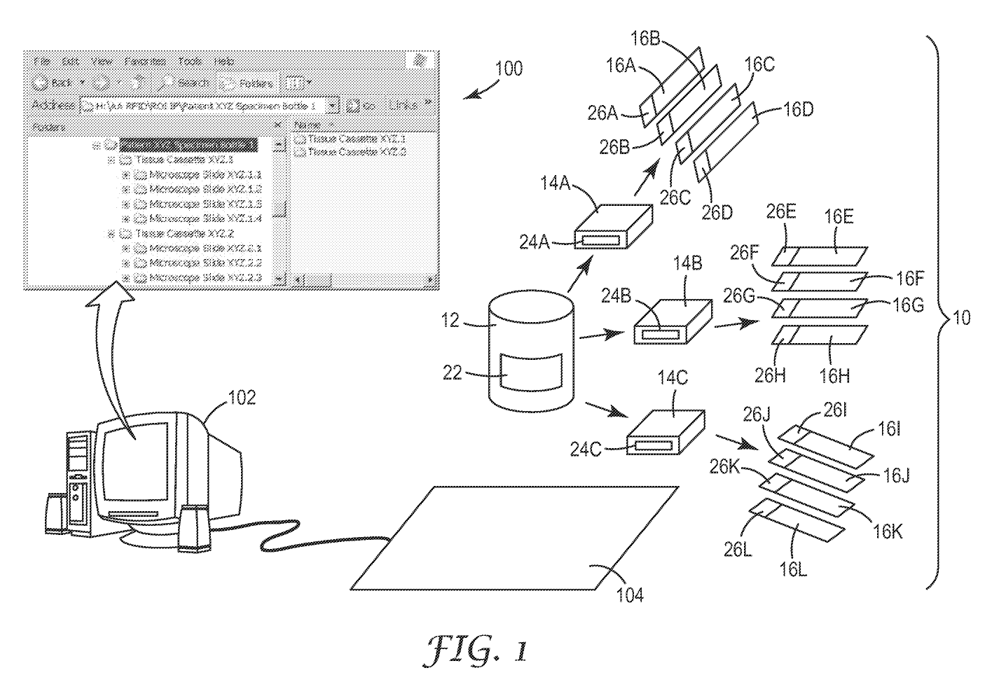

FIG. 1 illustrates how typically one specimen may be split up among many specimen cassettes and specimen slides. FIG. 1 illustrates a collection or set 10 of RFID tagged specimen containers. Each set 10 is affiliated with only one patient and preferably, none of the containers are be reused. The set 10 may include specimen containers of different types, for example, specimen bottles 12, specimen cassettes 14, and specimen slides 16. Specimen bottle 12 includes a first RFID tag 22. For this illustration, the specimen bottle 12 has been programmed with identification information XYZ.123. Specimen bottle 12 holds a specimen from the patient having identification information XYZ. Three different portions of the specimen in specimen bottle 12 may be placed in specimen cassettes 14A, 14B, and 14C. A portion of the specimen is placed into a cassette 14 and dehydrated. The slots in the cassette 14 allow the dehydrating process fluids to flow through the cassette 14 and bathe the specimen sample. After dehydration, the specimen sample is removed from the cassette 14H and placed in a mold cup that attaches to the bottom of the cassette. Hot wax (paraffin) then is poured through the cassette 14 into the mold cup, capturing the specimen and molding the specimen block to the cassette. Now the specimen is embedded in wax, attached to the bottom outside of the cassette, and ready for microtoming. Each specimen cassette 14A, 14B, 14C includes an individual RFID tag attached to it, 24A, 24B, and 24C, respectively. For this illustration, the RFID tag 24A has been programmed with identification information XYZ.123.456, which reflects the source of the specimen, which was the bottle XYZ.123, and includes unique information about the cassette 24A, which is extension 456. The RFID tag 24B has been programmed with identification information XYZ.123.457, which reflects the source of the specimen, which was the bottle XYZ.123, and includes unique information about the cassette 24A, which is extension 457. The RFID tag 24B has been programmed with identification information XYZ.123.458, which reflects the source of the specimen, which was the bottle XYZ.123, and includes unique information about the cassette 24A, which is extension 458. The specimen or portion of specimen in each cassette is dehydrated and embedded in wax in preparation for further processing.

Each specimen cassette 14 with its wax-embedded specimen is then used to derive individual specimen microscope slides 16, where each specimen microscope slide has its own RFID tag 26. Thin sections are shaved off in the microtome and floated onto microscope slides 16. The slides are dried down, and as the liquid is removed, surface tension pulls the thin microtomed section of the sample down onto the slide. The samples on the slide are stained, and optionally processed with microwave heating to accelerate the stain uptake into the sample, and thereafter cover slip glass is applied to the top and the finished slides are collected into case books or slide trays for the pathologist to look at portions of the specimen in the specimen cassette 14A are used to create specimens for the specimen slides 16A, 16B, 16C and 16D. Likewise, portions of the specimen in the specimen cassette 14B are used to create specimens for the specimen slides 16E, 16F, 16G and 16H. Likewise, portions of the specimen in the specimen cassette 14C are used to create specimens for the specimen slides 161, 16J, 16K and 16L. The RFID tag 26A on specimen slide 16A is programmed with identification information XYZ.123.456.701, which reflects identification information from RFID tag 24A, XYZ.123.456, which was the source of the specimens placed on specimen slide 16A, and with unique identification information about the specimen slide 16A, which is extension 701. Similarly, RFID tags 26B, 26C, and 26D are programmed with identification information, which reflects identification information from RFID tag 24A, XYZ.123.456, which was the source of the specimen, and with unique identification information about the specimen slide 16B: XYZ.123.456.702; 16C: XYZ.123.456.703; 16D: XYZ.123.456.704, respectively. This identification scheme allows a user to correctly identify the source of the sample to the exact patient the sample was originally taken from, and to have a good “chain of title” to know where each sample in the specimen container was originally obtained from. In this manner, the sets of RFID tagged containers 10 help ensure that the link between the bottles 12, cassettes 14 and slides 16 and the correct patient information is reliable and secure.

All the unique identifiers for the RFID tags for cassettes 14 and slides 16 are further recorded within the patient record within specimen management system. The slides 16 are then transferred to a pathologist office, while cassettes 14 and any remaining bottles 12 may be transferred to an archive, remain in the laboratory, or be discarded. The pathologist analyzes the specimens, such as by viewing slides 16 through a microscope, and produces a pathology report based on the analysis. Once the pathologist office is finished with slides 16, slides 16 may be sent to an archive for long-term storage. Upon arrival at the archive, information may be read from the bottles 12, cassettes 14, and slides 16 by another RFID reader within the archive associated with specimen management system 4. For example, the RFID reader may be used to check the bottles 12, cassettes 14 and slides 16 into the archive by updating the patient record within the specimen management system to reflect that the bottles 12, cassettes 14 and slides 16 are now located at archive.

Table 1 below illustrates examples of identification information that may be found on the RFID tags attached to each specimen, which follows the example discussed above and set out in FIG. 1.

TABLE 1
Identification Information on the RFID Tag for Each Specimen Container

| | Patient | Specimen, | Specimen | Specimen |
|---|---|---|---|---|
| | Identification | first level | second level | third level |
| | Bracelet | (Bottle) | (Cassette) | (Slide) |
| Patient | XYZ | XYZ.123 | XYZ.123.456 | XYZ.123.456.701 |
| XYZ | | | | XYZ.123.456.702 |
| | | | | XYZ.123.456.703 |
| | | | | XYZ.123.456.704 |
| | | | XYZ.123.457 | XYZ.123.457.901 |
| | | | | XYZ.123.457.902 |
| | | | | XYZ.123.457.903 |
| | | | | XYZ.123.457.904 |
| | | | XYZ.123.458 | XYZ.123.458.801 |
| | | | | XYZ.123.458.802 |
| | | | | XYZ.123.458.803 |
| | | | | XYZ.123.458.804 |
| | XYZ | XYZ.124 | XYZ.124.458 | XYZ.124.458.601 |
| | | | | XYZ.124.458.602 |
| | | | XYZ.124.459 | XYZ.124.459.801 |
| | | | | XYZ.124.459.802 |
| | | | | XYZ.124.459.803 |
| Patient | ABC | ABC.223 | ABC.223.456 | ABC.223.456.301 |
| ABC | | | | ABC.223.456.302 |
| | | | ABC.223.457 | ABC.223.457.501 |
| | | | | ABC.223.457.502 |
| | ABC | ABC.224 | ABC.224.567 | ABC.224.567.401 |
| | | | | ABC.224.567.402 |
| | | | ABC.224.568 | ABC.224.568.601 |
| | | | | ABC.224.568.602 |
| | | | ABC.224.569 | ABC.224.569.801 |
| | | | | ABC.224.569.802 |

Table 1 illustrates how identification information or similar nomenclature for each level of specimen integrates the identification information or nomenclature of the previous level. The Table also illustrates how each patient may provide one or more specimen, for example ABC.223 and ABC.224, and how each specimen at each level may generate one or more specimens at the next lower level, for example, portions of the specimen sample ABC.223 is ultimately is used to create specimens ABC.223.456.301, ABC.223.456.302. In this example, the entire patient identification is included in the bottle identification information. However, it is contemplated that only a portion of the entire patient identification information need be included in the bottle identification information, such as X or XY, as opposed to XYZ. That being said, the entire identification information thereafter is included in the further levels, for example, the first level (bottle) to the second level (cassette) and so on.

For purpose of illustration, the Table above shows the first level to be a collection of the specimen in a bottle 12; the second level represents the processing of the specimen into one or more tissue cassettes 14; the third level represents the preparation of a plurality of microscope slides 16. The specimen nomenclature indicates the patient (source of the specimen) and the level of the specimen in the analysis chain, for example, first, second or third level. The letter and number combinations in Table 1 are for illustrative purposes only.

Another way in which to illustrate a set of associated RFID tags of the present invention is to use the following nomenclature with a combination of letters. For example, Patient A may provide four different specimens A′, A″, A′″, and A″″. The specimens are placed in specimen bottles 12, and each RFID tag that is attached to the bottle is programmed with identification information, A′, A″, A′″, and A″″, respectively. The specimen in the bottle having RFID tag A′ is then further reduced at the next level of process to, for example, produce three specimens in cassettes, where the identification information programmed into the RFID tags on the cassettes 14 is A′a, A′a′, and A′a″, respectively. Then, the specimen in the cassette 14 having identification information A′a is further reduced in a third level of the process to produce samples A′a α, A′a α′, and A′a α″. As another example, specimen bottle 12 having identification information A″ may be reduced to three samples having identification information A″b, A″b′, and A″b″, respectively. These samples may be placed in specimen cassettes 14 and each associated RFID tag may be programmed with the appropriate identification information. Then, the specimen sample having identification information A″b is further reduced to three samples having specimen identification information A″b β, A″b β′, and A″b β″, respectively, where each sample is placed on a specimen slide 16. As another example, the specimen having identification information A′″ that is in a specimen bottle 12 may be reduced to three samples of specimen to be put in cassettes 14 having identification information on their RFID tags A′″c, A′″c′, and A′″c″, respectively. As yet another example, a portion of the specimen sample having identification information A′″c is then used to create a microscope slide having an RFID tag with identification information A′″c γ programmed into the RFID tag.

To provide yet another illustration, continuing with the letter nomenclature for identification information on RFID tags and referring to FIG. 1, a first specimen bottle 12 having identification information A′ on its RFID tag 22 holds a first specimen. The patient from which this specimen was taken has identification information A. A second specimen container, cassette 14A, holds a portion of the specimen from the first specimen container, specimen bottle 12. The RFID tag 24A on the second container, cassette 14A, is programmed with identification information A′a. A third specimen container microscope slide 26A, is prepared by using a portion of the specimen contained in second specimen container, cassette 14A. The third specimen container, microscope slide26A, has an RFID tag 26A, which is programmed with identification information A′aα. A fourth specimen container, cassette 14B, holds a portion of the specimen found in first specimen container, specimen bottle 12. The RFID tag 24B attached to cassette 14B is programmed with identification information A′b. A fifth specimen container, cassette 14B is prepared using a portion of the specimen found in the first container, specimen bottle 12. The fifth specimen container has an RFID tag 16E programmed with identification information A′bβ. A sixth specimen container (not shown) is prepared using an original specimen taken from the patient. The RFID tag attached to sixth specimen container is then programmed with identification information A″.

As another example, since the different levels of specimens each depend or originate from a patient or a previous specimen, the relationship between the different levels of specimen may be thought generically in terms of “parent,” “daughter” and “granddaughter.” Again referring to FIG. 1, specimen container 12 may be thought of as the “parent” specimen. Specimen container 14 may be thought of as the “daughter” specimen. Specimen container 16 may be thought of as the “granddaughter” specimen. Alternatively, the relationship between the different levels of specimen may be thought generically in terms of “root,” “branch” and “stem.” Specimen container 12 may be thought of as the “root” specimen. Specimen container 14 may be thought of as the “branch” specimen. Specimen container 16 may be thought of as the “stem” specimen.

Regardless of what naming scheme or nomenclature is chosen, the identification information is used to identify a set 10 of associated RFID tagged containers, where all the specimens are derived from the same patient. In this manner, these techniques are used to track patient-specific materials throughout a specimen collection and analysis process. The techniques disclosed herein are used to ensure proper association between a patient and the bottles 12, cassettes 14, and slides 16, and ultimately with the pathologist report on the specimens.

Continuing with FIG. 1, all of the RFID tagged containers in set 10 may be read by an RFID reader, for example via an RFID reader pad 104 with an embedded antenna. Alternatively, the RFID reader could be a hand held reader or a fixed reader in an enclosure. One or more of the specimen containers in the set 10 may be read by placing the containers on the antenna pad 104. Also, identification information may also be written to the integrated chips of the RFID tags by the antenna pad 104. One example of a commercially available RFID reader pad is 3M™ Model 810 Pad Reader. Antenna pad 104 is attached electronically via an RFID reader to a computing device 102, such as a computer. The computing device 102 may present a user interface 100 for accessing a specimen management system, and the user interface may guide a user through the process of programming each of the RFID tags on the specimen containers 12, 14, 16. One example of a specimen management software system is disclosed in U.S. Ser. No. 11/683,940, “Specimen Tracking and Management.” (Eisenberg et al.), which is hereby incorporated by reference. Overall, use of the associated set of RFID tagged containers simplifies the interface to the end user. The end user sees the same data structure for each of the RFID tag types and learns one common set of software instructions to track the specimen and its derivative portions. The end user requires only one type of reader to encode and read all of the RFID labels at all steps in the process, i.e. from patient intake and initial collection of the specimens to ultimate reporting of results of the analysis to the patient.

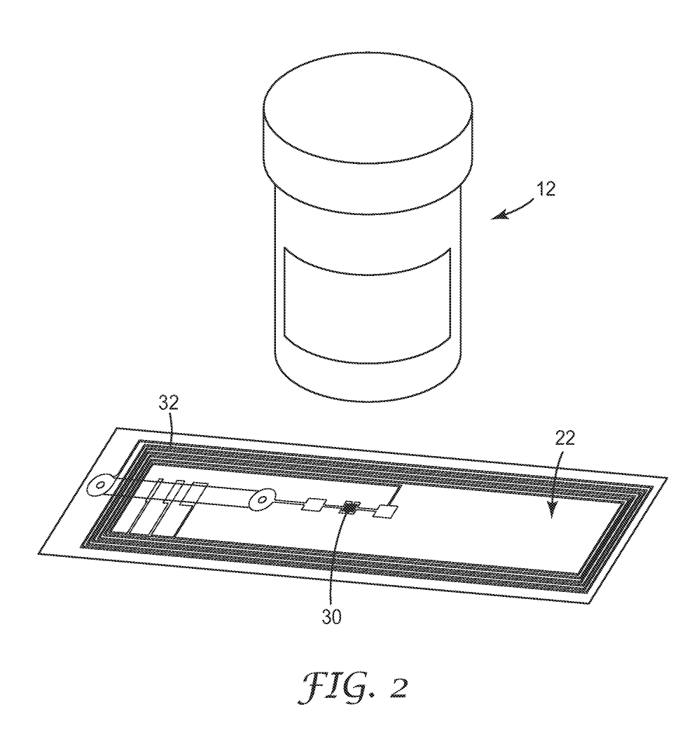

FIGS. 2-4 illustrate embodiments of suitable specimen containers having RFID tags. The RFID tags 22, 24, 26 all include antennas 32 which may be dissimilar in size, and are sized to fit the container for which they are intended. Even though the antennas 32 may be sized differently, they are intended to function using a common RFID protocol to make it easy for the user to use one type of RFID reader to read the RFID tags 22, 24, 26.

FIG. 2 illustrates one embodiment of a specimen bottle 12. RFID tag 22 is illustrated as incorporated into a label and is waiting to be adhered to the specimen bottle 12. RFID tag 22 includes an integrated circuit electrically attached to an antenna 32. The RFID label 22 is illustrated with the integrated circuit 30 attached to a first major surface of the RFID antenna 32, and the printable label stock is attached to the second major surface of the RFID antenna 32. In an alternative construction (not shown), the printable label stock may be attached to the same first major surface of the antenna 32 as is the integrated circuit 30. In one particular embodiment, the RFID tag is designed to fit within a 25 mm×100 mm (1 inch×4 inch) label border. The outer dimensions of the RFID antenna are 20 mm×85 mm. In this particular embodiment, the RFID Bridge antenna design is configured to work with NXP's I-Code SLI integrated circuit or silicon die, which has 1 kBit (1024 bits) of memory, and is commercially available from NXP (formerly Philips Semiconductors), San Jose, Calif. Because the NXP I-Code SLI silicon die is ISO-15693 compatible, any RFID reader/writer that operates on the ISO-15693 protocol can read data from and write data to the specimen bottle RFID tag 22. In particular, the NXP I-Code SLI ISO-15693 silicon die is compatible with the 3M™ Library Systems Model 810 Pad Reader and the 3M™ Digital Library Assistant (DLA) Hand Held Reader, commercially available from 3M Company, St. Paul, Minn. The 3M Library Systems and Medical Specimen Tracking hardware and software systems that have been developed around the ISO-15693 protocol may be used to interact with the Specimen Bottle RFID tag 22 in this associated set 10 of RFID containers.

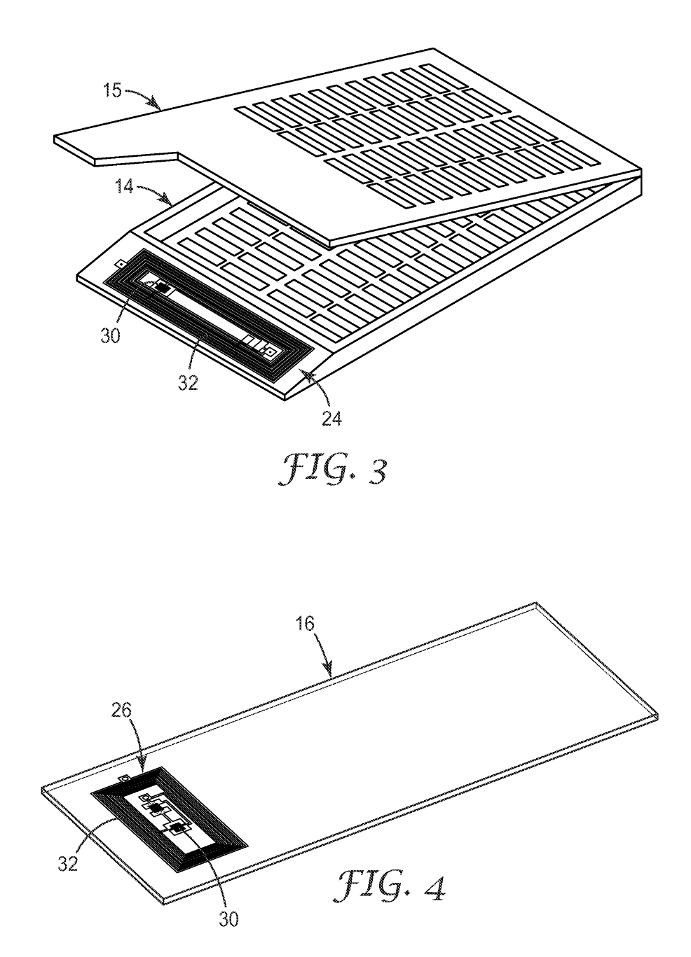

FIG. 3 illustrates another type of specimen container, where the specimen container is a cassette 14 having a lid 15. As explained above, the tissue may be dehydrated, then embedded in wax to form a block attached to cassette 14. Cassette 14 has an RFID tag 24 sized to fit the inclined edge of the cassette. In one embodiment, this RFID tag 24 incorporates a high aspect ratio (long, narrow) RFID antenna. In one embodiment, the antenna may have outer dimensions ranging from 5-8 mm by 24-32 mm. In one particular embodiment, the high aspect ratio RFID antenna has outer dimensions of 7 mm×28 mm. Despite its small size, the high aspect ratio RFID label 24 of FIG. 3 is designed to work with the same NXP I-Code SLI silicon die as used for the specimen bottle RFID tag 22.

As with the specimen bottle tag 22, the cassette RFID tag 24 also incorporates the NXP I-Code SLI silicon die or integrated chip 30 into the high aspect ratio transponder antenna 32. This silicon die or integrated chip 30, operating according to the ISO-15693 RFID protocol, is compatible with the 3M Library Systems Model 810 Pad Reader and the 3M Digital Library Assistant (DLA) Hand Held Reader. The 3M Library Systems and Medical Specimen Tracking hardware and software systems that have been developed around the ISO-15693 protocol may be used to interact with the cassette RFID tag 24 in this associated set 10 of RFID containers.

The tissue cassette 14 poses a particular design challenge because of the limited area on the cassette where an RFID tag 24 may be installed. In one particular embodiment, the transponder antenna 32 outer dimensions are 7 mm×28 mm. In the illustrated example, the printable label stock has not been overlaid on the RFID transponder so that the fit of the transponder to the label area of the cassette is more easily visible. However, RFID tag 24 may be incorporated into a label by adding label stock and adhesive.

FIG. 4 illustrates another type of specimen holder, a microscope slide 16. As mentioned above, one or more slides may be prepared using tissue from a single specimen block in cassette 14. In particular, microscope slide 16 receives a small section of the sample that is microtomed or otherwise removed from the processed sample in the tissue cassette 14. The microscope slide RFID tag incorporates a miniature RFID antenna 32. In one embodiment, the antenna may have outer dimensions ranging from 5-8 mm by 24-32 mm. In one particular example, the miniature RFID antenna has outer dimensions of 8 mm×17 mm. In this embodiment, the miniature RFID tag 26 of FIG. 4 is designed to work with the same NXP I-Code SLI silicon die or integrated circuit as used for the specimen bottle RFID tag 22. To achieve resonance with the RFID system operating at 13.56 MHz, an additional capacitor may preferably be included in the miniature RFID tag.

As with the specimen bottle RFID tag 22, the microscope slide RFID tag 26 incorporating the NXP I-Code SLI silicon die is compatible with the 3M™ Library Systems Model 810 Pad Reader and the 3M™ Digital Library Assistant (DLA) Hand Held Reader. The 3M Library Systems and Medical Specimen tracking hardware and software systems that have been developed around the ISO-15693 protocol may be used to interact with the microscope slide RFID tag 26 in this associated set 10 of RFID tagged containers.

As with the tissue cassette 14, the microscope slide 16 poses a design challenge because of the limited area on a typical microscope slide where a label may be installed. A typical microscope slide is 25 mm×75 mm. On some slides, an area at one end of the slide approximately 20 mm×25 mm is frosted to accept printed or hand-written labels. The miniature RFID tag 26 fits easily within this limited area on the microscope slide. The transponder antenna 32 outer dimensions are 8 mm×17 mm. In this example, printable label stock has not been overlaid on the RFID tag 26 so that the fit of the tag in the label area of the microscope slide is more easily visible. However, RFID tag 26 may be incorporated into a label by adding label stock and adhesive.

Preferably, the set 10 of RFID tags of the present invention and RFID readers for communicating with the RFID tags use substantially the same or more preferably, the same RFID communication protocol to read data from or write data to the RFID tags for the specimen containers 12, 14, 16 regardless of type of container. One example of an appropriate RFID protocol is ISO-15693 RFID protocol. In addition, it is preferred that the integrated circuits 30 used within the set 10 of RFID tags all have similar physical operating parameters. By this we mean, for example, that the integrated circuits may have a common memory structure and similar AC and DC electrical operating characteristics. More preferably, the use of a single, common integrated circuit among all RFID tag types allows for a standard data format to be used among all the RFID tags pertaining to the original specimen. With the common data format and identical on-board memory structure for the integrated circuits, identification data can be easily written to all of the samples derived from one original specimen.

The RFID tags in the set 10 are preferably intended to be used once for only one patient specimen and thus constructed in any manner known in the art to render the tag not reusable, to avoid mistakes in patient identification of samples. Preferably, all the RFID tags are able to function in multiple environments, particularly those experienced in a laboratory or a hospital. An example of one environment is a microwave oven. A slide-mounted histological or pathological specimen may be heated by microwave radiation in a microwave oven to speed up the biological stain infusion process. Because of this potential for microwave radiation exposure for the microscope slide RFID tag 26, the antenna 32 of the tag may be designed to include features that make the tag functional (i.e., is able to be successfully read by an RFID reader) after receiving electromagnetic radiation generated by a microwave source. One example of such an RFID tag is disclosed in U.S. Ser. No. 11/610,243, “Microwaveable Radio Frequency Identification Tags, (Egbert et. al), which is hereby incorporated by reference. As another example, the specimen cassettes 14 are processed in dehydration solvent baths, for example, isopropyl alcohol and xylene.

As mentioned above, the RFID tags of the present invention may be incorporated into RFID labels by adding a label stock and adhesive. The labels may be printable, for example, by a common printer. The label stock and adhesive may be chosen by one skilled in the art for the intended environments that the RFID label may experience. For example, the materials of the RFID labels may be chosen to protect the integrated circuits and antennas from harsh chemicals typically used during the specimen process, such as isopropyl alcohol and xylene. For example, the label and adhesive adjacent the outer edges of the label may form a water proof barrier to protect the sensitive integrated circuit and antenna from aqueous solutions of process chemicals or stains, alcohols, or hydrocarbons.

The RFID tags themselves may take any number of forms without departing from the scope of the present invention. Examples of commercially available RFID tags include 3M™ RFID tags available from 3M Company, Saint Paul, Minn., or “Tag-it” RFID transponders available from Texas Instruments, Dallas, Tex. Additionally, methods of making the RFID tags are disclosed in U.S. Ser. No. 11/610,243, “Microwavable Radio Frequency Identification Tags,” (Egbert et al.).

The methods for using the set 10 of RFID tagged containers of the present invention may include the following steps: after the specimen is placed in the specimen bottle 12, the unique patient identification number is programmed and any other suitable information, such as identification information about the specific specimen bottle 12 into the memory in the RFID tag 22 attached to the specimen bottle 12. This programming may be completed while the RFID label is attached to the specimen bottle 12 and the specimen bottle 12 is on or near a reader. Alternatively, the programming may occur in a specially equipped printer that can print identification information in human-readable form and, using an internal RFID writer, encode the silicon integrated circuit 30 in the tag 22 before it exits the printer with the identification information and other such data as may be desired. When derivative specimens are created, such as specimens for cassettes 14 or microscope slides 16, where a portion of the specimen from the bottle is used for the cassette and a portion of the specimen from the cassette is used for the microscope slide, the RFID tags for the derivative samples may be printed with human-readable data and the RFID tag programmed in the printer, as with the specimen bottle tag 22. The data to be printed and programmed may be taken from a patient record in a computer database. Such an alternate method for programming the data in the RFID tags on derivative samples will reduce the work done by the human technician and reduce the possibility of errors. With the specimen bottle RFID tag programmed with the unique patient identification number and identification information about the bottle, the specimen bottle RFID tag can be read by an RFID reader (hand-held or desk-top pad), and with appropriate programming of the reader control software, the appropriate unique identification data can be written by the RFID reader/writer to all the RFID tags on all the derivative samples with additional specific specimen container identification information. In this scenario, the reading of patient identification information from the specimen bottle is automated. The writing of derivative data to each of the derivative samples in RFID tagged containers is automated and removes the possibility of human data transcription errors.

The selection of an RFID integrated circuit with user-programmable memory allows the user to program each label with a user-selected alphanumeric unique identification. Within the limits of the on-die memory (1 kBit, or 256 characters in this Example), the data recorded to the RFID tag may also include a date code (procedure date or patient birth date, for example), procedure code or abbreviated description, doctor name or license number, facility code, or other alphanumeric data.

Although the legal record of the procedure and results likely would be maintained in paper files or in a secure database, rather than on the specimen RFID tag itself, the alphanumeric data recorded electronically to the memory in the RFID tag in the specimen bottle, tissue cassette(s), and microscope slide(s) labels provide a second means of identification of the specimen and its derivatives. The RFID labels can be electronically read and verified independently from the human interaction with the human-readable data printed or written on the specimen and its derivative samples. The RFID labels can be used to automate the sample processing, with an electronic data capture process, backed up by human-readable printed information or an electronic database on a host computer system.

This invention, the integrated suite of RFID labels for Medical Specimens, makes it possible for one RFID system (readers, software, and host computer) to manage the original specimen and all its derivative samples.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

1. An associated set of radio frequency identification (“RFID”) tagged containers for collecting and processing one or more specimens from a patient, comprising:
a first specimen container having a first RFID tag attached to the first container;
a second specimen container having a second RFID tag attached to the second container;
wherein the first specimen container includes a specimen from a patient, and the first RFID tag is programmed with identification information associated with the patient and identification information associated with the first specimen container, wherein the second specimen container includes a portion of the specimen from the first specimen container, and the second RFID tag is programmed with at least the identification information from the first RFID tag and identification information associated with the second specimen container;
wherein the first and second RFID tags include substantially the same communication protocol for reading data from or writing data to the RFID tags; and
wherein the first and second RFID tags include integrated circuits having similar physical operating parameters.

2. The associated set of RFID tagged containers of claim 1, further comprising:
a third specimen container having a third RFID tag attached to the third container;
wherein the third specimen container includes a portion of specimen from the second specimen container, and wherein the third RFID tag is programmed with the identification information from the second RFID tag and identification information associated with the third specimen container.

3. The associated set of RFID tagged containers of claim 2, wherein the identification information associated with the patient includes identification information A, wherein the first RFID tag includes identification information A′, wherein the second RFID tag includes identification information A′a, and wherein the third RFID tagged specimen container includes identification information A′aα.

4. The associated set of RFID tagged containers of claim 3, wherein a fourth RFID tagged specimen container includes identification information A′b, wherein a fifth RFID tagged specimen container includes identification information A′bβ, wherein a sixth RFID tagged specimen container includes identification information A″,
wherein the fourth specimen container includes a portion of the specimen from the first specimen container, and the fifth specimen container includes a portion of the specimen from the fourth specimen container, and wherein the sixth specimen container includes another specimen from the patient.

5. The associated set of RFID tagged containers of claim 2, wherein the first, second and third specimen containers are different types of containers.

6. (canceled)

7. The associated set of RFID tagged containers of claim 1, wherein the first and second RFID tags include antennas which are dissimilar in size.

8. The associated set of RFID tagged containers of claim 1, wherein the first and second RFID tags include the same communication protocol for reading data from or writing data to the RFID tags, and wherein the integrated circuits of the first and second RFID tags include a common memory structure.

9. The associated set of RFID tagged containers of claim 1, wherein the first and second RFID tags include adhesive and label stock for forming printable labels, and wherein the materials of the RFID labels protect the integrated circuits and antennas from harsh chemicals.

10. The associated set of RFID tagged containers of claim 1, wherein the RFID tags are not reusable.

11. The associated set of RFID tagged containers of claim 1, wherein the RFID tags are functional in different environments.

12. An associated set of radio frequency identification (“RFID”) tagged containers for collecting and processing one or more specimens from a patient, comprising:
a first specimen container having a first RFID tag attached to the first container;
a second specimen container having a second RFID tag attached to the second container;
a third specimen container having a third RFID tag attached to the third container;
wherein the RFID tags include substantially the same communication protocol for reading data from or writing data to the RFID tags; and
wherein the RFID tags include integrated circuits having similar physical operating parameters;
wherein the RFID tags include antennas which are dissimilar in size; and
wherein the first specimen container is a specimen bottle, the second specimen container is a specimen cassette, and the third specimen container is a specimen slide.

13. The associated set of RFID tagged containers of claim 12, wherein the first specimen container includes a specimen from a patient, and the first RFID tag is programmed with identification information associated with the patient and identification information associated with the first specimen container, wherein the second specimen container includes a portion of the specimen from the first specimen container, and the second RFID tag is programmed with at least the identification information from the first RFID tag and identification information associated with the second specimen container; wherein the third specimen container includes a portion of specimen from the second specimen container, and wherein the third RFID tag is programmed with the identification information from the second RFID tag and identification information associated with the third specimen container.

14. The associated set of RFID tagged containers of claim 13, wherein the identification information associated with the patient includes identification information A, wherein the first RFID tag includes identification information A′, wherein the second RFID tag includes identification information A′a, and wherein the third RFID tagged specimen container includes identification information A′aα.

15. The associated set of RFID tagged containers of claim 14, wherein a fourth RFID tagged specimen container includes identification information A′b, wherein a fifth RFID tagged specimen container includes identification information A′bβ, wherein a sixth RFID tagged specimen container includes identification information A″,
wherein the fourth specimen container includes a portion of the specimen from the first specimen container, and the fifth specimen container includes a portion of the specimen from the fourth specimen container, and wherein the sixth specimen container includes another specimen from the patient.

16. (canceled)

17. (canceled)

18. The associated set of RFID tagged containers of claim 12, wherein the first, second, and third RFID tags include the same communication protocol for reading data from or writing data to the RFID tags; and wherein the integrated circuits of the first, second, and third RFID tags include a common memory structure.

19. The associated set of RFID tagged containers of claim 12, wherein the first, second, and third RFID tags include adhesive and label stock for forming printable labels, and wherein the materials of the RFID labels protect the integrated circuits and antennas from harsh chemicals.

20-21. (canceled)

22. A method of forming an associated set of radio frequency identification (“RFID”) tagged containers for collecting and processing one or more specimens from a patient, comprising:
providing a first specimen container having a first RFID tag attached to the first container, a second specimen container having a second RFID tag attached to the second container, and a third specimen container having a third RFID tag attached to the third container;
supplying the first specimen container with a specimen from a patient, supplying the second specimen container with a portion of the specimen from the first specimen container, supplying the third specimen container with a portion of the specimen from the second specimen container,
programming the first RFID tag with identification information associated with the patient and identification information associated with the first specimen container, programming the second RFID tag with at least the identification information from the first RFID tag and identification information associated with the second specimen container, programming the third RFID tag with at least the identification information from the second RFID tag and identification information associated with the third specimen container;
wherein the first, second, and third RFID tags include substantially the same communication protocol for reading data from or writing data to the RFID tags; and
wherein the first, second, and third RFID tags include integrated circuits having similar physical operating parameters.

23. The method of claim 22, wherein the RFID tags include antennas which are dissimilar in size; and
wherein the first specimen container is a specimen bottle, the second specimen container is a specimen cassette, and the third specimen container is a specimen slide.

24. The method of claim 22, wherein the identification information associated with the patient includes identification information A, wherein the first RFID tag includes identification information A′, wherein the second RFID tag includes identification information A′a, wherein the third RFID tagged specimen container includes identification information A′aα.

25. The method of claim 24 further comprising the steps of:
providing a fourth specimen container having a fourth RFID tag attached to the fourth container, a fifth specimen container having a fifth RFID tag attached to the fifth container, a sixth specimen container having a sixth RFID tag attached to the sixth container,
supplying the fourth specimen container with a portion of the specimen from the first specimen container, supplying the fifth specimen container with a portion of the specimen from the fourth specimen container, and supplying the sixth specimen container with another specimen from the patient.
programming the fourth RFID tag with identification information A′b, programming the fifth RFID tagged specimen container with identification information A′bβ, and programming the sixth RFID tagged specimen container with identification information A″.
